(19) United States
(12) Patent Application Publication
(10) Pub. No.: US 2010/0167176 A1
(43) Pub. Date: Jul. 1, 2010

(54) MANUFACTURING APPARATUS AND METHOD FOR FUEL CELL ELECTRODE MATERIAL ASSEMBLY, AND FUEL CELL

(76) Inventor: Kenichi Kawai, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/663,854

(22) PCT Filed: Jun. 3, 2008
(86) PCT No.: PCT/JP2008/060512

§ 371 Date: Dec. 10, 2009

(30) Foreign Application Priority Data
Jun. 13, 2007 (JP) 207-156053

(51) Int. Cl. H01M 4/02; B32B 37/00

(52) U.S. Cl. 429/523; 156/538; 156/361; 156/60; 156/64

(57) ABSTRACT

Provided is a manufacturing apparatus (100) for an electrode material assembly for a fuel cell, which apparatus bonds an electrode material to both faces of an electrolyte membrane (10) continuously transported. The manufacturing apparatus (100) includes a drive mechanism for transporting the electrolyte membrane (10) in a predetermined direction (66), and a tension relieving mechanism for relieving the tension on the transport direction of the electrolyte membrane (10). The drive mechanism can include a plurality of drive system rollers, and the tension relieving mechanism can include tension relieving devices (62), (72), (82), and (92), each interposed between each pair of the adjacent drive system rollers.

### TECHNICAL FIELD

The present invention relates to an apparatus and a method for manufacturing an electrode material assembly for a fuel cell, and more particularly to an apparatus and a method for manufacturing an electrode material assembly for a fuel cell, in which an electrode material is bonded to both surfaces of an electrolyte membrane being continuously transported, and a fuel cell including the fuel cell electrode material assembly.

### BACKGROUND ART

A structure of a general single cell (also referred to as a single cell of fuel cell) corresponding to the minimum unit of a fuel cell, particularly a schematic structure of a primary portion including an electrode portion, will be described. As illustrated in FIG. 7, a cathode catalyst layer 12 (also referred to as an oxidation electrode or a cathode electrode) and an anode catalyst layer 14 (also referred to as a fuel electrode or an anode electrode) are provided opposite to each other with an electrolyte membrane 10 being interposed therebetween, thereby forming a so-called membrane electrode assembly (MEA) 30. Further, a cathode diffusion layer 16 is provided on the outer side of the cathode catalyst layer 12 and an anode diffusion layer 18 is provided on the outer side of the anode catalyst layer 14, so that a membrane electrode diffusion layer assembly (MEGA) 40 is formed. In addition, a cathode side separator 26 having an oxidation gas channel 20 and a cell refrigerant channel 22 formed therein and an anode side separator 28 having a fuel gas channel 24 and a cell refrigerant channel 22 formed therein are integrally formed with the membrane electrode diffusion layer assembly (MEGA) 40 on the outer side of the cathode diffusion layer 16 and the outer side of the anode diffusion layer 18, respectively, by adhesion or thermocompression bonding, for example, and a single cell 50 is formed.

A fuel cell stack (also referred simply as a fuel cell) having a plurality of single cells 50 thus obtained layered so as to provide a desired electromotive force is being applied in various fields. A fuel cell stack generally generates electric power by supplying oxidation gas such as oxygen and air to the cathode catalyst layer 12 and fuel gas such as hydrogen to the anode catalyst layer 14. Such a fuel cell is normally controlled to be within a predetermined temperature range of approximately between 60° C. and 100° C. at the time of power generation. However, because heat is generated in association with a chemical reaction at the time of power generation, a refrigerant such as water and ethylene glycol is caused to flow through the cell refrigerant channel 22 in order to prevent superheating of the fuel cell.

In order to achieve a reduction in manufacturing costs, mass production of fuel cells have been considered. For example, a variety of methods for performing a series of layering steps in line processing, such as bonding electrode materials including a catalyst layer material and a diffusion layer material sequentially to predetermined positions on both surfaces of a belt-like electrolyte membrane which is being continuously transported to form a membrane electrode assembly (MEA) and/or a membrane electrode diffusion layer assembly (MEGA), and to further manufacture a single cell including a gasket and a separator continuously in series of steps, have been considered.

JP 2005-190946 A describes technology in which, after an MEA is assembled on a separator belt formed by shaping a belt-like sheet material and forming a separator therein, the assembly is divided to form individual single cells.

JP 2005-183182 A describes technology in which, in order to increase the positioning accuracy at the time of bonding, a film tension portion for eliminating bending of an electrolyte membrane at the time of transportation is provided, and bonding is performed using, as a reference, positioning marks and transport holes provided regularly at edge portions of the electrolyte membrane.

JP 2004-356075 A and JP 2006-116816 A describe technology of transporting an electrolyte membrane in a state in which a predetermined tension is maintained so as to prevent generation of wrinkles on the electrolyte membrane or the like.

JP 2005-129292 A describes a member having assemblies including a catalyst layer layered on a web-shape electrolyte membrane continuously fed, in which a positioning sensor is applied so as to perform layering of diffusion layers and division of assemblies with high accuracy.

On the other hand, an electrolyte membrane, especially in a heated state, exhibits a nature of being easily extended even with application of slight tension. Such a property of the electrolyte membrane is one of the major factors which prevent continuous and high-speed production. Further, stable control of transportation of an electrolyte membrane having a high deformation property is one of the significant objects which would affect functionality or durability based on an assembling accuracy of a fuel cell.

When manufacturing a fuel cell with a series of processing steps, a variation in the water content and the processing temperature of the electrolyte membrane between each processing step may lead to various deficiencies. If an excessive tension is applied to a surface of an electrolyte membrane during the heating processing, extension of the electrolyte membrane in the transportation direction, and cross leakage of reaction gas due to a reduction in the membrane thickness caused by such an extension, for example, may occur. Also, a further excessive tension applied to the electrolyte membrane may lead to rupture or damage of the electrolyte membrane.

On the other hand, in order to bond the electrode materials such as a catalyst layer and a diffusion layer sequentially at predetermined positions on the surface of an electrolyte membrane, it is necessary to layer the electrode materials with high precision and with predetermined timing, in accordance with the transportation speed of the electrolyte membrane being transported. However, under conditions in which an interval between each assembly is not uniform due to contraction and/or extension of an electrolyte membrane, it is also necessary to adjust the timing for supplying the electrode materials or the like to be layered next, which generally complicates the system structure. While it may be considered to decrease the manufacturing speed or adjust the temperature and water content in the environment during transportation to thereby suppress occurrence of such deficiencies, in such a case, advantages of reduction in the manufacturing costs by a continuous production system cannot be expected.

The present invention provides an apparatus and a method for manufacturing a fuel cell material assembly, which allows continuous manufacturing of a fuel cell with high assembling accuracy.

### DISCLOSURE OF INVENTION

The structures of the present invention are as follows.

(1) A manufacturing apparatus for an electrode material assembly for a fuel cell, the manufacturing apparatus bonding an electrode material to each of two surfaces of an electrolyte membrane continuously transported and including a drive mechanism which transports the electrolyte membrane in a predetermined direction and a tension relieving mechanism which relieves tension in the transport direction of the electrolyte membrane.

(2) In the above manufacturing apparatus, the drive mechanism includes a plurality of drive units and the tension relieving mechanism includes tension relieving units each provided between each pair of the drive units.

(3) In the above manufacturing apparatus, a plurality of processing locations for applying different types of processing to the electrolyte membrane being transported are provided, and the tension relieving mechanism includes tension relieving units independently provided with regard to the processing locations, respectively.

(4) In the above manufacturing apparatus, each of the plurality of processing locations has processing rollers through which the electrolyte membrane passes and the circumference of each processing roller is set based on a difference in processing time among the processing locations.

(5) In the above manufacturing apparatus, each of the plurality of processing locations has a plurality of processing rollers through which the electrolyte membrane passes, and the number of the processing rollers at each processing location is set based on a difference in processing time among the processing locations.

(6) In the above manufacturing apparatus, each of the tension relieving units includes a plurality of tension relieving devices.

(7) A manufacturing apparatus for an electrode material assembly for a fuel cell, the manufacturing apparatus including a supply unit which supplies an electrode material on a surface of an electrolyte membrane being continuously transported; an information acquiring unit which acquires movement information of the electrolyte membrane; and a supply control unit which controls supply of the electrode material by the supply unit based on the movement information which is acquired, wherein the movement information is information concerning a position of the electrolyte membrane.

(8) A manufacturing apparatus for an electrode material assembly for a fuel cell, the manufacturing apparatus including a supply unit which supplies an electrode material on a surface of an electrolyte membrane being continuously transported; an information acquiring unit which acquires movement information of the electrolyte membrane; and a supply control unit which controls supply of the electrode material by the supply unit based on the movement information which is acquired, wherein the movement information is information concerning a speed of the electrolyte membrane.

(9) In the above manufacturing apparatus, the movement information is information concerning a position of a specific portion of the electrolyte membrane.

(10) In the above manufacturing apparatus, the movement information is information concerning a speed of a specific portion of the electrolyte membrane.

(11) In the above manufacturing apparatus, the information acquiring unit identifies an identifier provided in a specific portion of the electrolyte membrane to acquire the movement information of the electrolyte membrane.

(12) In the above manufacturing apparatus, a bonding unit which bonds the electrode material onto a surface of the electrolyte membrane is further provided, and bonding conditions of the electrode material are controlled in accordance with a change of a transportation speed of the electrolyte membrane.

(13) In the above manufacturing apparatus, the electrode material includes an electrode catalyst layer material which is previously formed on a surface of a sheet-like base material and which is to be supplied to a predetermined position of a surface of the electrolyte membrane and bonded thereto.

(14) In the above manufacturing apparatus, the electrode material further includes an electrode diffusion layer material which is previously formed in a sheet-like form and which is to be supplied to a surface of the electrode catalyst layer material bonded to the surface of the electrolyte membrane, and bonded thereto.

(15) A fuel cell including the electrode material assembly for a fuel cell manufactured by the above manufacturing apparatus.

(16) A manufacturing method for an electrode material assembly for a fuel cell, which is formed of an electrode material bonded on each of two surfaces of an electrolyte membrane, the manufacturing method including a step of continuously transporting the electrolyte membrane; a plurality of processing steps of applying different types of processing to the electrode membrane being transported; and a tension relieving step of relieving tension of the electrolyte membrane in a transportation direction, wherein the tension relieving step is performed at least corresponding to each of the processing steps.

(17) A manufacturing method for an electrode material assembly for a fuel cell, the manufacturing method including a step of acquiring movement information of an electrolyte membrane being continuously transported; and a step of controlling supply of the electrode material based on the movement information which is acquired, wherein the movement information includes information concerning a position of a specific portion of the electrolyte membrane.

(18) A manufacturing method for an electrode material assembly for a fuel cell, the manufacturing method including a step of acquiring movement information of an electrolyte membrane being continuously transported; and a step of controlling supply of the electrode material based on the movement information which is acquired, wherein the movement information includes information concerning a speed of a specific portion of the electrolyte membrane.

(19) A fuel cell including the electrode material assembly for a fuel cell which is manufactured by the above manufacturing method.

### BRIEF DESCRIPTION OF THE DRAWINGS

These and other objects of the invention will be explained in the description below, in connection with the accompanying drawings, in which:

FIG. 1 is a view schematically illustrating a structure of an electrode material assembly manufacturing apparatus according to an embodiment of the present invention;

FIG. 2 is an enlarged view schematically illustrating the structure of the electrode material assembly manufacturing apparatus according to the embodiment of the present invention;

FIG. 3 is an enlarged view schematically illustrating the structure of the electrode material assembly manufacturing apparatus according to the embodiment of the present invention;

FIG. 4 is an enlarged view schematically illustrating the structure of the electrode material assembly manufacturing apparatus according to the embodiment of the present invention;

FIG. 5 is a view schematically explaining a structure of processing members according to another embodiment of the present invention;

FIG. 6 is a perspective view schematically illustrating the structure of the electrode material assembly manufacturing apparatus according to the embodiment of the present invention; and

FIG. 7 is a view schematically illustrating a structure of a single cell.

### DESIGNATION OF NUMERICAL REFERENCES

10: electrolyte membrane
12: cathode catalyst layer (material)
14: anode catalyst layer (material)
16: cathode diffusion layer (material)
18: anode diffusion layer (material)
20: oxidation gas channel
22: cell refrigerant channel
24: fuel gas channel
26: cathode side separator
28: anode side separator
30: membrane electrode assembly (MEA)
40: membrane electrode diffusion layer assembly (MEGA)
50: single cell
52: cathode side seal member material
54a, 54b: catalyst layer material supply unit
56: anode side seal member material
55: catalyst layer material supply control unit
58, 68, 78: bonding unit
60, 61, 70, 71, 80, 81: processing roller
62, 72, 82, 92: tension relieving device (mechanism)
63, 73, 83, 93: tension relieving control unit
64a, 64b: diffusion layer material supply unit
65: diffusion layer material supply control unit
66: transportation direction
74a, 74b: seal member material supply unit
75: seal member material supply control unit
84: supply roller
86, 86a, 86b: transportation roller
88: take-up roller
90: membrane electrode diffusion layer/seal member assembly
94, 96, 98: information acquiring unit
100: electrode material assembly manufacturing apparatus
102: processing member
104: processing belt
106: roll
108: base material
110: electrode catalyst layer bonding device (first processing device)
120: electrode diffusion layer bonding device (second processing device)
130: seal member bonding device (third processing device)

### BEST MODE FOR CARRYING OUT THE INVENTION

Preferred embodiments of the present invention will be described with reference to the drawings. Throughout the drawings, the same elements are designated with the same numerical references and will not be described repeatedly. Further, the ratio of dimensions in the drawings differs from the actual ratio.

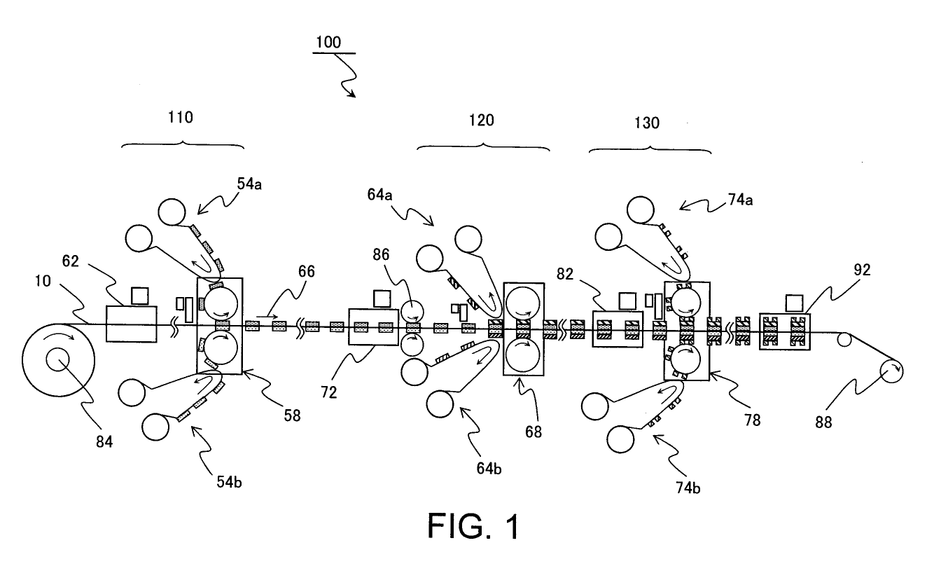

FIG. 1 is a view schematically illustrating a manufacturing apparatus for an electrode material assembly for a fuel cell (also referred to as “a fuel cell electrode material assembly”) according to an embodiment of the present invention. Referring to FIG. 1, a manufacturing apparatus for a fuel cell electrode material assembly 100 includes a first processing device 110, a second processing device 120, a third processing device 130, and a tension relieving mechanism (a first tension relieving device 62, a second tension relieving device 72, a third tension relieving device 82, and a fourth tension relieving device 92), and sequentially bonds each electrode material on both surfaces of an electrolyte membrane 10 being continuously transported in the direction of an arrow 66 from a supply roller 84, thereby manufacturing a fuel cell electrode material assembly.

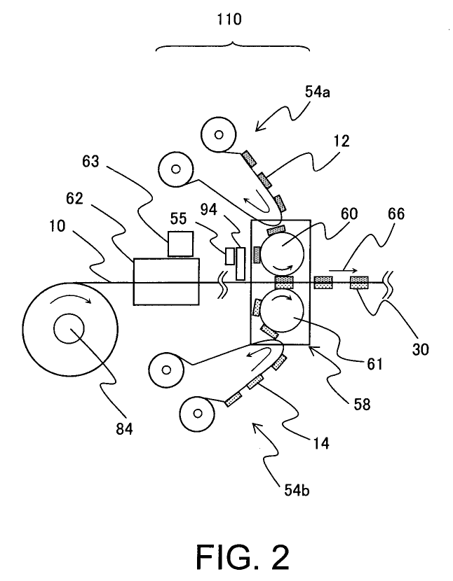

FIGS. 2 to 4 are views in which the first processing device 110, the second processing device 120, and the third processing device 130 and portions around thereof are enlarged, respectively, in order to explain the manufacturing apparatus 100 for a fuel cell electrode material assembly illustrated in FIG. 1 in further detail.

Referring first to FIG. 2 which is an enlarged view of the first processing device 110 and the vicinity thereof illustrated in FIG. 1, the first processing device 110 is an electrode catalyst layer bonding device which bonds the electrode catalyst layer materials 12 and 14 at predetermined positions on the respective surfaces of the electrolyte membrane 10 being continuously transported from the supply roller 84, to thereby produce an MEA 30.

The electrode catalyst layer assembling device (the first processing device) 110 illustrated in FIG. 2 includes a cathode catalyst layer material supply unit 54a, an anode catalyst layer material supply unit 54b, and a first bonding unit 58. The cathode catalyst layer material supply unit 54a is configured to be capable of supplying the cathode catalyst layer material 12 to the first bonding unit 58 by a supply belt such as a conveyor, for example. The anode catalyst layer material supply unit 54b, on the other hand, is configured to be capable of supplying the anode catalyst layer material 14 to the first bonding unit 58 by a conveyor-like transporting belt and so on, for example.

The cathode catalyst layer material 12 and the anode catalyst layer material 14 supplied to the first bonding unit 58 are transferred to processing rollers 60 and 61 within the first bonding unit 58, respectively, and thereafter supplied to the respective surfaces of the electrolyte membrane 10 at predetermined timing and bonded thereto. At this time, an interval between the processing rollers 60 and 61 is previously adjusted such that a predetermined pressure can be applied to the cathode catalyst layer material 12 and the anode catalyst layer material 14 to be layered on the respective surfaces of the electrolyte membrane 10. With the rotation of the processing rollers 60 and 61 in the directions of arrows, the electrolyte membrane 10 and each of the catalyst layer materials 12 and 14 are nipped between the processing rollers 60 and 61 with pressure and bonded together, to thereby form the MEA 30. Here, in another embodiment, it is also preferable that, when nipping the electrolyte membrane 10 and each of the catalyst layer materials 12 and 14 with pressure, the processing rollers 60 and 61 are heated to a predetermined temperature, as desired, to accelerate manufacturing of the MEA by thermocompression bonding.

In FIG. 2, as the cathode catalyst layer material 12 and the anode catalyst layer material 14 supplied by the catalyst layer material supply units 54a and 54b, respectively, a so-called catalyst ink in a fluid or paste state, obtained by dispersing each catalyst layer raw material, in which a catalyst containing a metal or an alloy including platinum or the like is carried by a catalyst carrier such as a carbon material including carbon black, in a dispersion medium such as water or ethanol, for example, can be applied. More specifically, for example, it is possible to adopt a structure in which the catalyst ink as described above is applied by spraying or coating onto a surface of a sheet-like base material, which is previously prepared, in a desired shape of a catalyst layer, and is then dried, and thereafter the catalyst layer thus formed is bonded to the electrolyte membrane.

However, the present invention is not limited to this structure. For example, in another embodiment, it is possible to adopt a structure in which a material corresponding to the catalyst ink described above is directly coated or spayed onto a surface of the electrolyte membrane 10 being continuously transported. Further, compositions of the cathode catalyst layer material 12 and the anode catalyst layer material 14 may be the same or different from each other.

On the other hand, a first information acquiring unit 94 which detects and acquires information concerning the electrolyte membrane 10 being moved is provided upstream of the first processing device 110 (i.e. on the supply roller 84 side) in FIG. 2. A catalyst layer material supply control unit 55 is capable of controlling timing for supplying the catalyst layer materials 12 and 14 by the catalyst layer material supply units 54a and 54b, respectively, based on the information acquired by the first information acquiring unit 94.

The first information acquiring unit 94 detects information recorded (printed) in a specific portion of the electrolyte membrane 10, e.g. a phototube mark or information corresponding to the phototube mark which is recorded (printed) with a visible or invisible ink and so on, in a non-contact manner to obtain the information concerning the electrolyte membrane 10. In another embodiment, the first information acquiring unit 94 can be configured to identify an identifier (e.g. a mark having an optical characteristic (e.g. color), a code inscribed in the electrolyte membrane 10, and/or numerals (e.g. a serial number), and so on) provided at a specific portion of the electrolyte membrane 10 to thereby obtain moving information of the electrolyte membrane 10.

The catalyst layer material supply control unit 55, on the other hand, based on the information obtained by the first information acquiring unit 94, controls supply of the catalyst layer materials 12 and 14 by the catalyst layer material supply units 54a and 54b, respectively, to supply the cathode catalyst layer material 12 and the anode catalyst layer material 14 to the respective surfaces of the electrolyte membrane 10 at predetermined timing.

Here, the information concerning the electrolyte membrane 10 being transported, which is acquired by the first information acquiring unit 94, may be information concerning the position of the electrolyte membrane 10, for example, or information concerning the speed of the electrolyte membrane 10. The catalyst layer material supply control unit 55 can also be configured to control supply of each catalyst layer material, based on a combination of the information concerning the position and/or the speed of the electrolyte membrane 10 acquired by the first information acquiring unit 94 with information concerning the tension relieving mechanism which will be described below.

Here, the information concerning the position of the electrolyte membrane 10, which is obtained by the first information acquiring unit 94, may be information of a coating edge surface which has been previously coated on the electrolyte membrane 10, and based on this position information on a specific portion of the electrolyte membrane 10, the timing for supplying each of the catalyst layer materials 12 and 14 onto the electrolyte membrane 10 can be controlled. However, the present invention is not limited to this example, and may also have a structure in which supply control is performed based on the transportation speed of the electrolyte membrane 10 and detection by a position sensor of an image of a processing position previously formed on the electrolyte membrane 10, for example.

On the other hand, the information concerning the speed of the electrolyte membrane 10, which is acquired by the first information acquiring unit 94, may be speed information of the membrane obtained by using the Doppler effect, or information concerning the transportation speed of the electrolyte membrane 10 obtained by dividing an interval between the information acquiring units by a difference in time points (i.e. passing time) at which a specific portion (recorded portion) of the electrolyte membrane 10 passes through at least two information acquiring units provided at predetermined intervals, and based on this speed information, the timing for supplying each of the catalyst layer materials 12 and 14 onto the electrolyte membrane 10 can be controlled. However, the present invention is not limited to the above structure.

Here, the processing rollers 60 and 61 can also serve as drive rollers which assist transportation of the electrolyte membrane 10 on which the MEA 30 is formed in the direction of arrow 66. More specifically, rotation of the processing rollers 60 and 61 in the directions indicated in FIG. 2 in a state in which the processing roller 60 and 61 nip each of the catalyst layer materials 12 and 14 and/or the electrolyte membrane 10 by pressure can be at least a portion of transportation drive force with respect to the electrolyte membrane 10 and can also be a factor for generating tension with respect to the electrolyte membrane 10. Accordingly, in the present embodiment, in order to achieve tension relieving with respect to the electrolyte membrane 10, it is preferable to adopt a structure in which the peripheral speed of the processing rollers 60 and 61 can be controlled in accordance with the transportation speed of the electrolyte membrane 10. In addition, it is also preferable that a difference between the transportation speed of the electrolyte membrane 10 being transported to the first bonding unit 58 and the peripheral speed of the processing rollers 60 and 61 for supplying each of the catalyst layer materials 12 and 14 onto the electrolyte membrane 10 is minimized to a level which can prevent damage to the membrane, and more specifically, to a degree at which such a difference in speed falls within a range of the elastic region of the electrolyte membrane 10, thereby preventing friction and slip from being generated between each of the catalyst layer materials 12 and 14 (MEA 30) and the processing rollers 60 and 61 at the time of pressure nip of each of the catalyst layer materials 12 and 14 by the processing rollers 60 and 61. In this case, if slip of the drive rollers is not caused, a transportation roller 86 illustrated in FIG. 1 is not necessary.

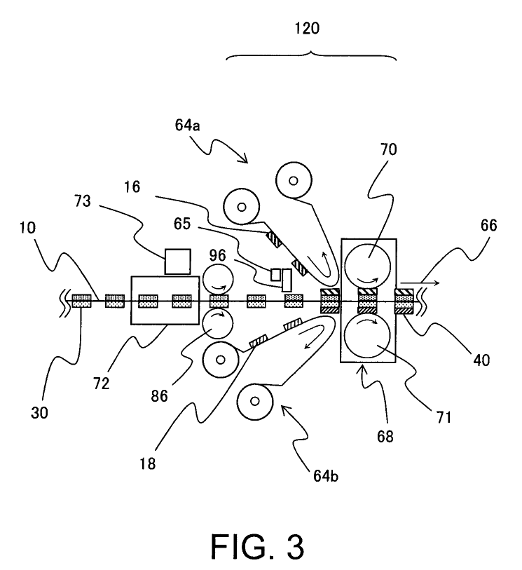

FIG. 3 is a view illustrating the second processing device 120 and the vicinity thereof illustrated in FIG. 1 in an enlarged manner. Referring to FIG. 3, the second processing device 120 is an electrode diffusion layer bonding device which bonds electrode diffusion layer materials 16 and 18 onto the respective surfaces of the MEA 30, which is formed by bonding the electrode catalyst layer materials 12 and 14 to predetermined positions on the respective surfaces of the electrolyte membrane 10 continuously transported, thereby forming an MEGA 40.

The electrode diffusion layer bonding device (the second processing device) 120 includes a cathode diffusion layer material supply unit 64a, an anode diffusion layer material supply unit 64b, and a second bonding unit 68. The cathode diffusion layer material supply unit 64a and the anode diffusion layer material supply unit 64b are configured to be capable of supplying the cathode diffusion layer material 16 and the anode diffusion layer material 18 to the respective surfaces of the MEA 30, respectively, at predetermined timing by a conveyor-like transporting belt.

On the other hand, the second bonding unit 68 includes processing rollers 70 and 71 having a predetermined interval therebetween and capable of rotating in the directions of arrows. The interval between the processing rollers 70 and 71 is previously adjusted such that a predetermined pressure can be applied to the cathode diffusion layer material 16 and the anode diffusion layer material 18 to be layered on the respective surfaces of the MEA 30. With the rotation of the processing rollers 70 and 71 in the directions of arrows, the MEA 30 and each of the diffusion layer materials 16 and 18 are nipped between the processing rollers 70 and 71 with pressure and bonded together, to thereby form an MEGA 40. Here, it is also preferable that, when nipping the MEA 30 and each of the diffusion layer materials 16 and 18 with pressure, the processing rollers 70 and 71 are heated to a predetermined temperature, as desired, to accelerate manufacturing of the MEGA 40 by thermocompression bonding.

In FIG. 3, as the cathode diffusion layer material 16 and the anode diffusion layer material 18 supplied by the diffusion layer material supply units 64a and 64b, respectively, a material which generally includes, as a base material, carbon fibers formed in a sheet shape having predetermined width and length, such as carbon paper and carbon cloth, and which is processed as follows, may be used. Specifically, the material is processed by using a binder such as polytetrafluoroethylene (PTFE) or other hydration processing material to provide desired hydrophobic or hydrophilic properties, in order to ensure desired air permeability or electron conduction and also to prevent flooding caused by retention of water content within the catalyst layers and diffusion layers. Further, it is also preferable to additionally use conductive particles such as carbon particles as required, to thereby increase the conductivity.

Further, in the embodiment illustrated in FIG. 3, the cathode diffusion layer material 16 and the anode diffusion layer material 18 which have been previously processed to a predetermined shape in accordance with the shape of the MEGA 40 (i.e. a shape which is substantially the same as those of the cathode catalyst layer material 12 and the anode catalyst layer material 14 except for their thickness) are used. In another embodiment, however, it is also preferable to provide a cutting member (which is not shown) such as a rotary cutter in a part of each of the diffusion layer supply units 64a and 64b to cut a series of cathode diffusion layer material 16 and a series of anode diffusion layer material 18 being transported into a predetermined shape and supply and bond these diffusion layer materials 16 and 18 which have been cut in the predetermined shape to the MEA 30.

On the other hand, a second information acquiring unit 96 which detects and acquires information concerning the electrolyte membrane 10 and/or the MEA 30 being moved is provided upstream of the second processing device 120 in FIG. 3. A diffusion layer material supply control unit 65 is capable of controlling timing for supplying the diffusion layer materials 16 and 18 by the diffusion layer material supply units 64a and 64b, respectively, based on the information acquired by the second information acquiring unit 96. Specifically, it is possible to detect, using a position sensor, the transportation speed of the electrolyte membrane 10 and an image of a processed position (e.g. a transferred and processed edge surface in the previous process, and so on) which is previously formed on the electrolyte membrane 10. However, the present invention is not limited to this example structure.

The second information acquiring unit 96 detects information recorded (printed) in a specific portion of the electrolyte membrane 10, e.g. a phototube mark or information corresponding to the phototube mark which is recorded (printed) with a visible or invisible ink and so on, in a non-contact manner to obtain the information concerning the electrolyte membrane 10. In another embodiment, the second information acquiring unit 96 can be configured to identify an identifier (e.g. a mark having an optical characteristic (e.g. color), a code inscribed in the electrolyte membrane 10, and/or numerals (e.g. a serial number), and so on) provided at a specific portion of the electrolyte membrane 10 to thereby obtain movement information of the electrolyte membrane 10.

The diffusion layer material supply control unit 65, on the other hand, based on the information acquired by the second information acquiring unit 96, controls supply of the diffusion layer materials 16 and 18 by the diffusion layer material supply units 64a and 64b, respectively, to supply the cathode diffusion layer material 16 and the anode diffusion layer material 18 onto the respective surfaces of the MEA 30 at predetermined timing.

Here, the information concerning the electrolyte membrane 10 being transported, which is acquired by the second information acquiring unit 96, may be information concerning the position of a specific portion of the electrolyte membrane 10, for example, or information concerning the speed of a specific portion of the electrolyte membrane 10. The diffusion layer material supply control unit 65 can also be configured to control supply of each diffusion layer material, based on a combination of the information concerning the position and/or the speed of the electrolyte membrane 10 acquired by the second information acquiring unit 96 with the information concerning the position and/or the speed of the specific portion of the electrolyte membrane 10 detected by the first information acquiring unit 94 illustrated in FIG. 2 and information concerning the tension relieving mechanism which will be described below.

Here, the information concerning the position of the specific portion of the electrolyte membrane 10, which is acquired by the second information acquiring unit 96, may be information of the edge surface of the catalyst or the like which is previously coated on the electrolyte membrane 10, and based on this position information on the specific portion of the electrolyte membrane 10, the timing for supplying each of the diffusion layer materials 16 and 18 to the MEA 30 can be controlled. However, the present invention is not limited to this example.

On the other hand, the information concerning the speed of the specific portion of the electrolyte membrane 10, which is acquired by the second information acquiring unit 96, may be information of the transportation speed of the electrolyte membrane 10 obtained by dividing a predetermined interval between at least two information acquiring units by a difference in time points (i.e. passing time) at which the specific portion (recorded portion) of the electrolyte membrane 10 passes through the at least two information acquiring units provided at the predetermined interval, and based on this speed information, the timing for supplying each of the diffusion layer materials 16 and 18 onto the MEA 30 can be controlled. However, the present invention is not limited to the above structure.

In another embodiment, it is also preferable to use a film thickness measuring device as the second information acquiring unit 96. For example, the position where the MEA 30 is formed is detected by using a difference of external dimensions (film thickness) between the MEA 30 formed by supplying the catalyst layer materials 12 and 14 at the predetermined positions on the electrolyte membrane 10 and the portion where the electrolyte membrane 10 is exposed. The cathode diffusion layer material 16 and the anode diffusion layer material 18 are supplied onto the MEA 30 in synchronization with each other based on the placement of the second information acquiring unit 96 including a film thickness measuring device and each of the diffusion layer material supply units 64a and 64b, and the transportation speed of the electrolyte membrane 10. According to the present embodiment, it is possible to avoid the situation in which a predetermined catalyst material has not been supplied on the surface of the electrolyte membrane 10 due to some deficiencies, and each of the diffusion layer materials 16 and 18 is supplied to a portion where a desired MEA 30 is not formed, which can contribute to an increase in yield of the cathode diffusion layer material 16 and the anode diffusion layer material 18.

Here, the processing rollers 70 and 71, similar to the processing rollers 60 and 61 illustrated in FIG. 2, can also serve as drive rollers which assist transportation of the electrolyte membrane 10 in the direction of arrow 66. More specifically, the rotation of the processing rollers 70 and 71 in the directions indicated in FIG. 3 in a state in which the processing roller 70 and 71 nip each of the diffusion layer materials 16 and 18 and/or the electrolyte membrane 10 therebetween by pressure can be at least a portion of transportation drive force with respect to the electrolyte membrane 10 and can also be a factor for generating tension with respect to the electrolyte membrane 10. Accordingly, in the present embodiment, in order to achieve tension relieving with respect to the electrolyte membrane 10, it is preferable to adopt a structure in which the peripheral speed of the processing rollers 70 and 71 can be controlled in accordance with the transportation speed of the electrolyte membrane 10. In addition, it is also preferable that a difference between the transportation speed of the electrolyte membrane 10 being transported to the second bonding unit 68 and the peripheral speed of the processing rollers 70 and 71 for bonding the respective diffusion layer materials 16 and 18 onto the MEA 30 by pressure is minimized to a degree of stress which does not cause tensile damage to the membrane, to thereby prevent friction and slip from being generated between each of the diffusion layer materials 16 and 18 (MEGA 40) and the processing rollers 70 and 71 at the time of nipping each of the diffusion layer materials 16 and 18 by pressure.

In another embodiment, when the processing time of the processing rollers 70 and 71 is extremely short and therefore the drive force of the rollers 70 and 71 with respect to the electrolyte membrane 10 cannot be expected (at this time, a level of slip which does not easily lower the quality of the electrolyte membrane is generally generated between the processing rollers and the electrolyte membrane), for example, it is preferable to use the transportation (auxiliary) roller 86 to positively transport the electrolyte membrane 10.

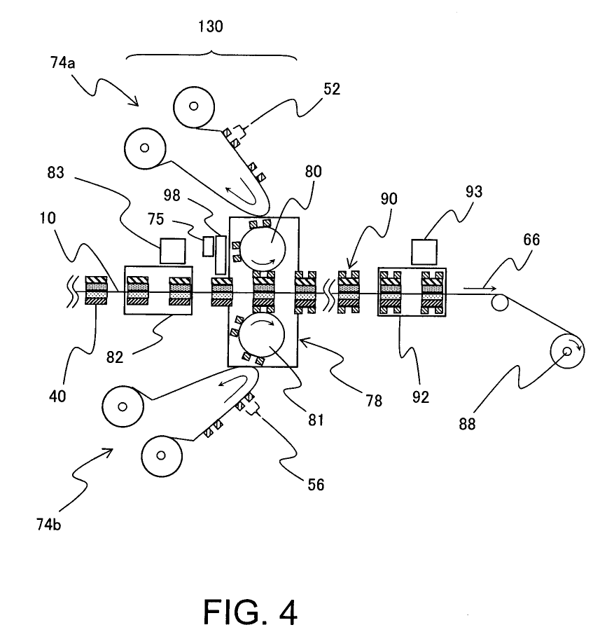

FIG. 4 is a view illustrating the third processing device 130 and the vicinity thereof illustrated in FIG. 1 in an enlarged manner. Referring to FIG. 4, the third processing device 130 is a seal member bonding device which bonds seal member materials 52 and 56 onto the respective surfaces of the MEGA 40 which is formed by bonding the electrode catalyst layer materials and the electrode diffusion layer materials to predetermined positions on the respective surfaces of the electrolyte membrane 10 being continuously transported, thereby forming an MEGA/seal member assembly 90.

The seal member bonding device (the third processing device) 130 illustrated in FIG. 4 includes a cathode side seal member material supply unit 74a, an anode side seal member material supply unit 74b, and a third bonding unit 78. The cathode side seal member material supply unit 74a is configured to be capable of supplying the cathode side seal member material 52 to the third bonding unit 78 at predetermined timing by a conveyor-like transporting belt, for example. On the other hand, the anode side seal member material supply unit 74b is configured to be capable of supplying the anode side seal member material 56 to the third bonding unit 78 at predetermined timing by a conveyor-like transporting belt, for example.

The cathode side seal member material 52 and the anode side seal member material 56 supplied to the third bonding unit 78 are transferred to the processing rollers 80 and 81, respectively, within the third bonding unit 78, and thereafter supplied to the respective surfaces of the MEGA 40 at predetermined timing and bonded to the MEGA 40. The interval between the processing rollers 80 and 81 is previously adjusted such that a predetermined pressure can be applied to the cathode side seal member material 52 and the anode side seal member material 56 to be layered on the respective surfaces of the MEGA 40. With the rotation of the processing rollers 80 and 81 in the directions of arrows, the MEGA 40 and each of the seal member materials 52 and 56 being sequentially transported are bonded together by nipping these members by the processing rollers 80 and 81 with pressure, to thereby form an MEGA/seal member assembly 90. In another embodiment, it is also preferable that, when nipping the MEGA 40 and each of the seal member materials 52 and 56 with pressure, the processing rollers 80 and 81 are heated to a predetermined temperature, as desired, to accelerate manufacturing of the MEGA/seal member assembly 90 by thermocompression bonding.

In FIG. 4, the cathode side seal member material 52 and the anode side seal member material 56 are disposed on the outer peripheral portion of a manifold through which a fluid such as reaction gas and a refrigerant communicates in a fuel cell stack, for example, and may include a gasket or linear seal which prevents leakage of each fluid communicating through this manifold to the outside and/or entering of a foreign material, including a different type of fluid, into the manifold. As the cathode side seal member material 52 and the anode side seal member material 56, an elastic material such as ethylene propylene rubber, fluoro rubber, silicone rubber, for example, may be used alone or in an appropriate combination. Here, the cross sectional shapes of the cathode side seal member material 52 and the anode side seal member material 56 illustrated in FIG. 4 are merely examples, and may be any shapes other than those illustrated in FIGS. 1 and 4 and can be appropriately designed in accordance with the structure of a fuel cell to be manufactured.

On the other hand, a third information acquiring unit 98 which detects and acquires information concerning the electrolyte membrane 10 and/or the MEGA 40 being moved is provided upstream of the third processing device 130 in FIG. 4. A seal member material supply control unit 75 is capable of controlling timing for supplying the seal member materials 52 and 56 by the seal member material supply units 74a and 74b, respectively, based on the information acquired by the third information acquiring unit 98. Specifically, it is possible to detect, using a position sensor, the transportation speed of the electrolyte membrane 10 and an image of a processed position (e.g. a transferred and processed edge surface in the previous process, and so on) which is previously formed on the electrolyte membrane 10. However, the present invention is not limited to this example structure.

The third information acquiring unit 98 detects information recorded (printed) at a specific portion of the electrolyte membrane 10, e.g. a phototube mark or information corresponding to the phototube mark which is recorded (printed) with a visible or invisible ink and so on, in a non-contact manner to obtain the information concerning the electrolyte membrane 10. In another embodiment, the third information acquiring unit 98 can be configured to identify an identifier (e.g. a mark having an optical characteristic (e.g. color), a code inscribed in the electrolyte membrane 10, and/or numerals (e.g. a serial number), and so on) provided at a specific portion of the electrolyte membrane 10 to thereby obtain movement information of the electrolyte membrane 10.

The seal member material supply control unit 75, on the other hand, based on the information acquired by the third information acquiring unit 98, controls supply of the seal member materials 52 and 56 by the seal member material supply units 74a and 74b, respectively, to supply the cathode side seal member material 52 and the anode side seal member material 56 to the respective surfaces of the MEGA 40 at predetermined timing.

Here, the information concerning the electrolyte membrane 10 being transported, which is acquired by the third information acquiring unit 98, may be information concerning the position of a specific portion of the electrolyte membrane 10, for example, or information concerning the speed of a specific portion of the electrolyte membrane 10. The seal member material supply control unit 75 can also be configured to control supply of each of the seal member materials 52 and 56, based on a combination of the information concerning the position and/or the speed of the electrolyte membrane 10 acquired by the third information acquiring unit 98 with the information concerning the position and/or the speed of the specific portion of the electrolyte membrane 10 detected by the first information acquiring unit 94 illustrated in FIG. 2, the information concerning the position and/or the speed of the electrolyte membrane 10 acquired by the second information acquiring unit 96 illustrated in FIG. 3, and also the information concerning the tension relieving mechanism which will be described below.

The information concerning the position of the specific portion of the electrolyte membrane 10, which is acquired by the third information acquiring unit 98, may be information of the edge surface of the layers of MEGA 40 which is previously formed in the previous process or information concerning a mark processed simultaneously therewith, and based on this position information on the specific portion of the electrolyte membrane 10, the timing for supplying each of the seal member materials 52 and 56 onto the MEGA 40 can be controlled. However, the present invention is not limited to this example.

On the other hand, the information concerning the speed of the specific portion of the electrolyte membrane 10, which is acquired by the third information acquiring unit 98, may be information of the transportation speed of the electrolyte membrane 10 obtained by dividing a predetermined interval between at least two information acquiring units by a difference in time points (i.e. passing time) at which the specific portion (recorded portion) of the electrolyte membrane 10 passes through the at least two information acquiring units provided at the predetermined interval. Based on this speed information, the timing for supplying each of the seal member materials 52 and 56 onto the MEGA 40 can be controlled. However, the present invention is not limited to the above structure.

In another embodiment, it is also preferable to use a film thickness measuring device as the third information acquiring unit 98. For example, the position where the MEGA 40 is formed is detected by using a difference in the external dimensions (film thickness) between the MEGA 40 formed by supplying the diffusion layer materials 16 and 18 at the predetermined positions on the MEA 30 and the portion where the electrolyte membrane 10 is exposed. The cathode side seal member material 52 and the anode side seal member material 56 are supplied onto the MEGA 40 in synchronization with each other based on the placement of the third information acquiring unit 98 including a film thickness measuring device and each of the seal member material supply units 74a and 74b, and the transportation speed of the electrolyte membrane 10. According to the present embodiment, it is possible to avoid the situation in which each of the seal member materials 52 and 56 is supplied to a portion where a desired MEA 30 and/or MEGA 40 has not been formed on the electrolyte membrane 10 due to some deficiencies, which can contribute to increase in yield.

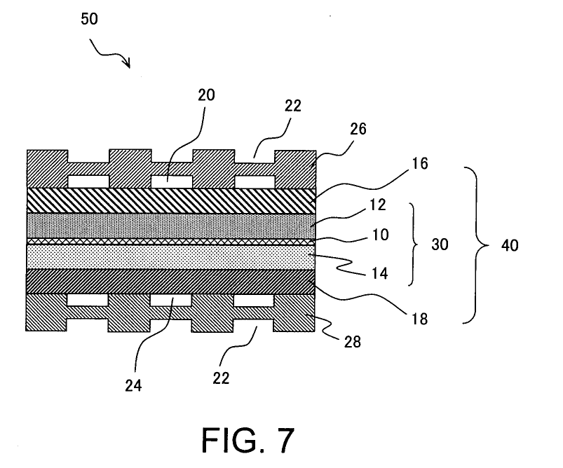

The MEGA/seal member assembly 90 which has been assembled within the third bonding unit 78 is then transported in the direction of arrow 66 and taken up by the take-up roller 88. However, when it is difficult to take up the MEGA/seal member assembly 90 due to the thickness thereof, the MEGA/seal member assembly 90 may be cut without being taken up by the roller 88. When the MEGA/seal member assembly 90 has been taken up, the MEGA/seal member assembly 90 is then cut by each unit in a separate device which is not illustrated, to further create a single cell 50 by using a member such as a separator (see FIG. 7) which is not illustrated in FIG. 4. Then, a predetermined number of single cells 50 are layered to form a fuel cell stack.

Here, the processing rollers 80 and 81, similar to the processing rollers 60 and 61 illustrated in FIG. 2, can also serve as drive rollers which assist transportation of the electrolyte membrane 10 in the direction of arrow 66. More specifically, the rotation of the processing rollers 80 and 81 in the directions indicated in FIG. 4 in a state in which the processing rollers 80 and 81 nip each of the seal member materials 52 and 56 and/or the electrolyte membrane 10 by pressure can be at least a portion of the transportation drive force with respect to the electrolyte membrane 10 and can also be a factor for generating tension with respect to the electrolyte membrane 10. Accordingly, in the present embodiment, in order to achieve tension relieving with respect to the electrolyte membrane 10, it is preferable to adopt a structure in which the peripheral speed of the processing rollers 80 and 81 can be controlled in accordance with the transportation speed of the electrolyte membrane 10. In addition, it is also preferable that a difference between the transportation speed of the electrolyte membrane 10 being transported to the third bonding unit 78 and the peripheral speed of the processing rollers 80 and 81 for bonding the respective seal member materials 52 and 56 onto the MEGA 40 by pressure is minimized, to thereby prevent friction and slip from being generated between each of the seal member materials 52 and 56 (membrane electrode diffusion layer/seal member assembly 90) and the processing rollers 80 and 81 at the time of pressure nip of the seal member materials 52 and 56 by the processing rollers 80 and 81.

In the embodiment described above, each of the bonding units 58, 68, and 78 illustrated in FIGS. 2 to 4 is configured to include a pair of processing rollers (60, 61), (70, 71), and (80, 81). Because the time during which processing can be performed by each pair of the processing rollers depends on the pressure contact time of the processing rollers, which is based on the transportation speed of the electrolyte membrane 10 and the circumference and the peripheral speed of the rollers, a desired processing time can be secured by adjusting these parameters. Specifically, in order to perform predetermined processing at each processing location with respect to the electrolyte membrane 10 being transported at a fixed speed, it is preferable to previously set the circumference (ratio) of each processing roller based on the difference in the processing time at each processing roller. According to the present embodiment, it is possible to perform predetermined processing at each processing roller (bonding unit) with the transportation speed of the electrolyte membrane 10 being fixed.

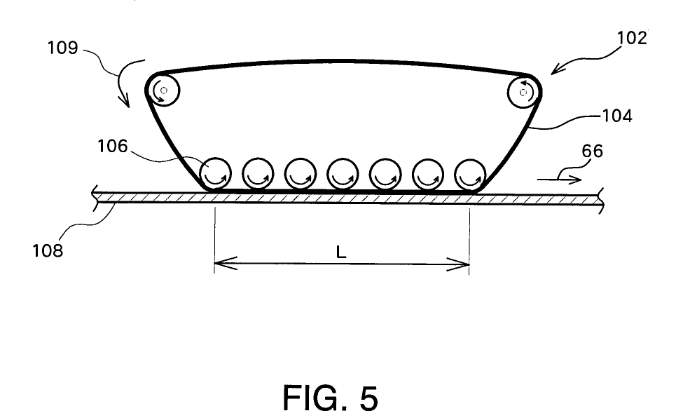

On the other hand, it is also preferable to perform processing by means of a plurality of processing rollers such as a series of processing members which adopt a caterpillar system including a plurality of rolls, as illustrated in FIG. 5. With the processing member 102 illustrated in FIG. 5, the plurality of rolls 106 are rotated in the direction of arrow (counterclockwise), so that a processing belt 104 rotates in the direction of arrow 109. When such a processing member 102 is applied in each processing portion, by appropriately setting the number of rollers based on the difference in the processing time between each processing portion, it is possible to maintain desired processing conditions in each processing portion even in a state in which the transportation speed of the base material 108 (the electrolyte membrane 10, the MEA 30, or the MEGA 40) being transported in the direction of arrow 66 is fixed. In FIG. 5, only the structure of the system located above the base material 108 is illustrated and the structure of the system located under the base material 108 is omitted. However, a structure including processing rollers having a predetermined circumference, or a processing member (processing belt) configured to include a plurality rolls and having a structure similar to that of the processing member 102 provided above the base material 108, for example, may be adopted.

In the present embodiment, it is also possible to adopt a structure which can appropriately adjust and optimize the processing conditions by varying the number of rolls 106 contacting the base material 108 to thereby change the contact length L between the processing belt 104 and the base material 108 or by changing a pressure force of the rolls 106 and the processing belt 104 onto the base material 108 (including a heating time when the rolls 106 are heating rolls) in accordance with a change of the transportation speed of the base material 108 being transported in the direction of arrow 66.

As described above, by performing formation of the assemblies, in which the processing rollers and the processing belt, which enable maximal elimination of the processing steps that require long processing time and that are likely to cause generation of deficiency when the apparatus is interrupted during the operation, such as the coating and drying steps, and which enable stable processing in a relative short time, are applied, continuous processing in accordance with the ability of the manufacturing apparatus can be performed and the efficiency of manufacturing the electrode material assemblies can be increased.

Further, while generation of tension with respect to the electrolyte membrane 10 during manufacturing can be suppressed to a certain degree by controlling the relative speed (peripheral speed) among the processing rolls provided at the respective bonding units 58, 68, and 78 to be substantially 0 in accordance with the transportation speed of the electrolyte membrane 10, suppression of tension is still insufficient.

The electrode material assembly manufacturing apparatus 100 according to the present embodiment illustrated in FIG. 1 performs a series of bonding processing with respect to the electrolyte membrane 10 being continuously transported, by driving (rotating) each of the drive mechanisms such as the plurality of drive rollers (transportation rollers) and processing rollers at the respective predetermined speeds (peripheral speeds). However, a slight delay or advance may actually occur with respect to the respective predetermined rotation speeds due to a difference in the motor properties or backlash of a speed reducer and so on in each rotation driving portion (the processing rollers and/or drive rollers). Such a slight change of the rotation period (speed) which can occur unavoidably may further cause a subtle change of the transportation speed of the base material including the electrolyte membrane 10, or the processing time. Consequently, an excessive tension is locally applied to the electrolyte membrane 10, which can cause not only expansion and rupture of the electrolyte membrane 10 but also processing (bonding) deficiencies. In order to address such an unavoidable malfunction resulting from the mechanical properties, the tension relieving mechanisms (the first tension relieving device 62, the second tension relieving device 72, the third tension relieving device 82, and the fourth tension relieving device 92) illustrated in FIG. 1 are effective.

The first tension relieving device 62 illustrated in FIGS. 1 and 2 is provided between the supply roller 84 and the electrode catalyst layer bonding device 110 and relieves the tension on the electrolyte membrane 10 generated in association with drive control of the supply roller 84 with respect to the electrolyte membrane 10, rotation of the processing rollers 60 and 61, and so on, to thereby suppress expansion of the electrolyte membrane 10 being continuous transported. When a tension sensing unit detects an increase in the tension with respect to the electrolyte membrane 10, a first tension relieving control unit 63 instructs tension relieving, so that predetermined tension relieving processing is performed at the first tension relieving device 62.

Various known tension relieving means can be applied as the first tension relieving device 62. For example, in order to absorb and adjust a local change in the length of the electrolyte membrane, it is preferable to provide, as required, one or more of mechanisms such as a mechanism which controls the transportation driving of the electrolyte membrane 10 to temporarily change the transportation speed thereby relieving the tension (e.g. a dancer roller), a transportation buffering device which, with the electrolyte membrane 10 being retained by a predetermined length, repeatedly performs an operation of rapidly supplying the electrolyte membrane 10 with respect to delayed transportation at the downstream portion while temporarily retaining the electrolyte membrane with respect to the excessive transportation from the upstream portion (e.g. an accumulator), and so on.

It is further possible to use, as the tension sensing unit (which is not illustrated) within the first tension relieving device 62, a rotary encoder which detects the transportation speed of the electrolyte membrane 10 from the supply roller 84 and causes the sensed speed to be reflected in control of the supply roller by means of a powder brake, or a tension pickup which causes the tension detected by a load cell installed within a roller to be reflected in control of the dancer roller, and so on. However, the tension sensing unit is not limited to the above examples. In another embodiment, it is also possible to adopt a structure in which a tension pickup, based on information concerning the tension obtained by the tension pickup itself, relieves the tension.

Further, in another embodiment, it is also preferable to adopt a structure in which, in addition to control of the first tension relieving device 62, control such as powder brake control or torque control which is generally incorporated in the supply roller 84 for controlling driving of the supply roller 84 is also performed by the first tension relieving control unit 63.

The second tension relieving device 72 illustrated in FIGS. 1 and 3 is provided between the electrode catalyst layer bonding device 110 and the transportation roller 86 or the electrode diffusion layer bonding device 120 in the vicinity of the transportation roller 86, and relieves the tension generated with respect to the electrolyte membrane 10 in association with bonding of the catalyst layer materials by rotation of the processing rollers 60 and 61, transportation control of the transportation roller 86, bonding of the diffusion layer materials by rotation of the processing and/or transportation rollers 70 and 71, and so on. When a tension sensing unit which is not illustrated detects an increase in the tension with respect to the electrolyte membrane 10, a second tension relieving control unit 73 instructs tension relieving, so that predetermined tension relieving processing is performed at the second tension relieving device 72.

As with the first tension relieving device 62, various known tension relieving means can be applied as the second tension relieving device 72 described above. The second tension relieving device 72 may be a device similar to the first tension relieving device 62 described above or may be used in a similar or different combination of the devices described above. The second tension relieving device 72 can be selected appropriately in accordance with the characteristics of the electrode catalyst layer bonding device 110, the transportation roller 86, and the electrode diffusion layer bonding device 120.

The third tension relieving device 82 illustrated in FIGS. 1 and 4 is provided between the electrode diffusion layer bonding device 120 and the seal member bonding device 130, and relieves the tension generated with respect to the electrolyte membrane 10 in association with bonding of the diffusion layer materials by rotation of the processing rollers 70 and 71, bonding of seal member materials by rotation of the processing rollers 80 and 81, and so on. When a tension sensing unit which is not illustrated detects an increase in the tension with respect to the electrolyte membrane 10, a third tension relieving control unit 83 instructs tension relieving, so that predetermined tension relieving processing is performed at the third tension relieving device 82.

As with the first tension relieving device 62 and the second tension relieving device 72, various known tension relieving means can be applied as the third tension relieving device 82 described above. The third tension relieving device 82 may be a device similar to the first tension relieving device 62 and/or the second tension relieving device 72 described above, or may be used in a similar or different combination of the devices described above. The third tension relieving device 82 can be selected appropriately in accordance with the characteristics of the electrode diffusion layer bonding device 120 and the seal member bonding device 130.

The fourth tension relieving device 92 illustrated in FIGS. 1 and 4 is provided between the seal member bonding device 130 and the take-up roller 88, and relieves the tension generated with respect to the electrolyte membrane 10 in association with bonding of the seal member materials by rotation of the processing rollers 80 and 81, take-up of the membrane electrode diffusion layer/seal member assembly 90 by rotation of the take-up roller 88, and so on. When a tension sensing unit which is not illustrated detects an increase in the tension with respect to the electrolyte membrane 10, a fourth tension relieving control unit 93 instructs tension relieving, so that predetermined tension relieving processing is performed at the fourth tension relieving device 92.

As with the first tension relieving device 62, the second tension relieving device 72, and the third tension relieving device 82, various known tension relieving means can be applied as the fourth tension relieving device 92 described above. The forth tension relieving device 92 may be a device similar to the first tension relieving device 62, the second tension relieving device 72, and/or the third tension relieving device 82 described above, or may be used in a similar or different combination of the devices described above. The fourth tension relieving device 92 can be selected appropriately in accordance with the characteristics of the seal member bonding device 130 and the take-up roller 88.

Further, in another embodiment, it is also possible to adopt a structure in which, in addition to the fourth tension relieving device 92, a tapered tension control mechanism (not illustrated) which is generally previously incorporated in the fourth tension relieving device 92 as a member forming a pair together with the take-up roller 88 and which is used for driving control of the take-up roller 88, is also controlled by the fourth tension relieving control unit 93.

It is preferable that the first tension reliving device 62, the second tension relieving device 72, the third tension reliving device 82, and the fourth tension relieving device 92, which form the tension relieving mechanism, are provided independently of each other, as illustrated in FIG. 1. By providing the first tension reliving device 62, the second tension relieving device 72, the third tension reliving device 82, and the fourth tension relieving device 92 independently between the respective pairs of the processing locations, rapid tension relieving control can be achieved even when tension is generated locally on the electrolyte membrane 10.

Further, in the electrode material assembly manufacturing apparatus 100 illustrated in FIG. 1, it is possible to secure desired processing quality not only when the electrolyte membrane 10 is operating at a stable speed, which is a desired transportation speed, for example, but also in a state in which a change in the transportation speed is significant, such as immediately after start of transportation (start of operation) and immediately before completion of transportation (stop of the operation), which state has been difficult to control by conventional electrode material assembly manufacturing apparatuses.

As described above, in the electrode material assembly manufacturing apparatus 100, the processing time at each processing location depends on the transportation speed of the electrolyte membrane 10. As described above, in order to avoid generation of tension with respect to the electrolyte membrane 10, it is preferable to minimize the difference between the transportation speed of the electrolyte membrane 10 and the peripheral speed of the processing roller. Accordingly, in a state in which the transportation speed of the electrolyte membrane 10 is gradually increased, such as immediately after the start of transportation, the processing time becomes shorter as the process advances compared to when the transportation speed is fixed. On the other hand, in a state in which the transportation speed of the electrolyte membrane 10 is gradually decreased, such as immediately before the termination of transportation, the processing time becomes longer as the process advances compared to when the transportation speed is fixed.

In order to maintain the excellent processing performance irrespective of such a change in the transportation speed of the electrolyte membrane 10, it is preferable to previously define preferable processing (bonding) conditions at a predetermined time at each processing location. Then, by controlling the processing conditions to the preferable conditions (e.g. the processing pressure and/or the processing temperature) in accordance with a change in the transportation speed, assemblies with high quality can be manufactured even under conditions in which the transportation speed is unstable.

On the other hand, when the transportation speed of the electrolyte membrane 10 is fixed, preferable processing can be performed at the respective processing locations by setting the peripheral speeds of the drive rollers and the processing rollers to substantially the same as described above. When slip is generated between the electrolyte membrane 10 being transported and each roller, such slip can be eliminated by reducing the transportation speed of the electrolyte membrane 10 (a dancer roller can be used, for example) or increasing the contact pressure between the electrolyte membrane and the roller at a predetermined position to a degree which does not increase the tension with respect to the electrolyte membrane 10.

In another embodiment of the present invention, it is possible to add or remove the drive system rollers such as the processing rollers. In FIG. 1, when the electrolyte membrane 10 having catalyst materials previously coated on the respective surfaces thereof is used as an electrode material, the first processing device 110 is not necessary, which enables omission of the tension relieving device 72 (or the tension relieving device 62) accordingly. Similarly, when drive rollers such as the processing rollers are added, preferable processing control can be performed by additionally providing a corresponding tension relieving device.

### EXAMPLES

The present invention will be described more specifically and in further detail with reference to the following examples. It should be noted, however, that the present invention is not limited to the following examples.

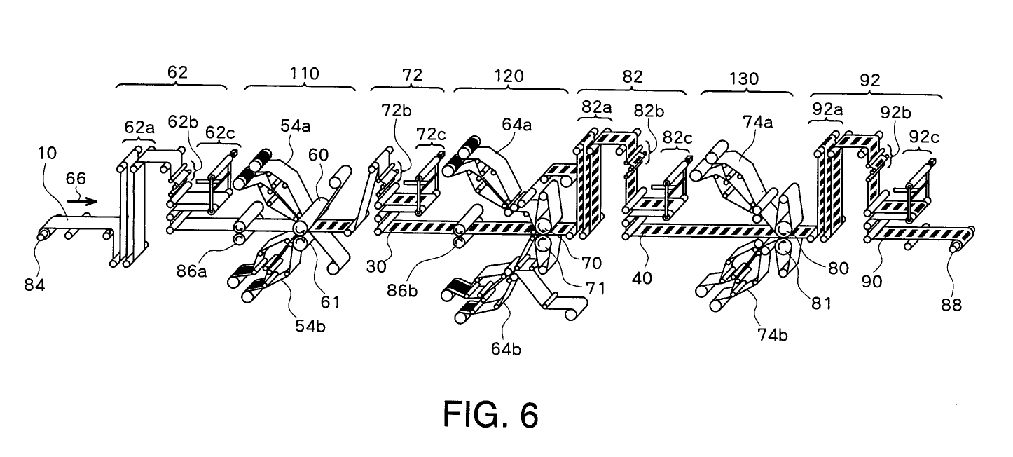

FIG. 6 is a perspective view schematically illustrating a structure of a manufacturing device for a fuel cell electrode material assembly according to the embodiment of the present invention. Here, structures of the material supply control units and the information acquiring units (see FIGS. 2 to 4), which enable execution of preferable placement of each of the materials to be bonded, such as a catalyst layer and a diffusion layer, at a predetermined position of the electrolyte membrane 10, are omitted.

Referring to FIG. 6, the electrolyte membrane 10 provided in a roll is unwound and fed from the supply roller 84 at a predetermined transportation speed. After the transportation speed of the electrolyte membrane 10 is adjusted by the transportation roller 86a provided immediately before the first processing device 110, the electrode catalyst layer materials are supplied and bonded to the electrolyte membrane 10 by the first processing device 110.

The first processing device 110 includes the cathode catalyst layer material supply unit 54a, the anode catalyst layer material supply unit 54b, and the heating and pressuring rollers (processing rollers) 60 and 61. In the present embodiment, a cathode catalyst layer material roll provided in a rolled shape is set on the cathode catalyst layer material supply unit 54a and an anode catalyst layer material roll provided in a rolled shape is set on the anode catalyst layer material supply unit 54b. The cathode catalyst layer material supply unit 54a and the anode catalyst layer material supply unit 54b supply the cathode catalyst layer material 12 and the anode catalyst layer material 14, respectively, to the respective surfaces of the electrolyte membrane 10 in accordance with transportation of the electrolyte membrane 10 from the feed roller 84. The cathode catalyst layer material 12 and the anode catalyst layer material 14 supplied to the respective surfaces of the electrolyte membrane 10 being transported are bonded to the electrolyte membrane 10 by thermocompression bonding for a predetermined time by rotation of the heating and pressuring rollers 60 and 61 which are set to a predetermined temperature and a predetermined nipping pressure, to form the MEA 30 at predetermined intervals.

On the other hand, the tension relieving device 62 including a first accumulator 62a, a first tension pickup 62b, and a first dancer roll 62c, is provided between the supply roller 84 and the first processing device 110 (the transportation roller 86a). The tension relieving device 62 relieves tension generated with respect to the electrolyte membrane 10 between the supply roller 84 and the transportation roller 86a, and is also capable of relieving, as desired, a slight difference in the transportation speed generated between the supply roller 84 and the transportation roller 86a.

The transportation speed of the electrolyte membrane 10 (MEA 30) having the MEA 30 formed thereon by the first processing device 110 is adjusted by the transportation roller 86b provided immediately before the second processing device 120, and thereafter the electrode diffusion layer material is supplied and bonded to the MEA 30 in the second processing device 120. In the second processing device 120, the cathode diffusion layer material supply unit 64a, the anode diffusion layer material supply unit 64b, and the heating and pressuring rollers (processing rollers) 70 and 71 are provided. The electrode catalyst layer materials 12 and 14 are supplied on the respective surfaces of the MEA 30 at predetermined transportation intervals and bonded to the MEA 30 by the heating and pressurizing rollers 70 and 71.

On the other hand, the tension relieving device 72, including a second tension pickup 72b and a second dancer roll 72c, is provided between the first processing device 110 (the processing roller 60 and 61) and the second processing device 120 (transportation roller 86b). The tension relieving device 72 relieves tension generated with respect to the electrolyte membrane 10 between the processing rollers 60 and 61 and the transportation roller 86b, and is also capable of relieving, as desired, a slight difference in the transportation speed generated between the transportation roller 86a and the transportation roller 86b.

After the MEGA 40 is formed in the second processing device 120, the seal member material is supplied and bonded to the MEGA 40 in the third processing device 130. In the third processing device 130, the cathode side seal member material supply unit 74a, the anode side seal member material supply unit 74b, and the heating and pressuring rollers (processing rollers) 80 and 81 are provided. The electrode catalyst layer materials 12 and 14 are supplied on the respective surfaces of the MEGA 40 at predetermined transportation intervals and bonded to the MEGA 40 by the heating and pressurizing rollers 80 and 81.

On the other hand, the tension relieving device 82 including a second accumulator 82a, a third tension pickup 82b, and a third dancer roll 82c is provided between the second processing device 120 (the processing rollers 70 and 71) and the third processing device 130 (the processing rollers 80 and 81). The tension relieving device 82 relieves tension generated with respect to the electrolyte membrane 10 between the processing rollers 70 and 71 and the processing rollers 80 and 81, and is also capable of relieving, as desired, a slight difference in the transportation speed generated between the transportation roller 86b and the processing rollers 80 and 81.

The electrolyte membrane 10 having the MEGA/seal member assembly 90 formed thereon in the third processing device 130 is thereafter taken up by the take-up roller 88. It is preferable to control the torque of the take-up roller 88 in accordance with take-up of the electrolyte membrane 10 (MEGA/seal member assembly 90) by the take-up roller 88 to thereby relieve the tension applied to the electrolyte membrane 10. At this time, in addition to the torque control by the take-up roller, the tension generated with respect to the electrolyte membrane 10 between the processing rollers 80 and 81 and the take-up roller 88 can be relieved by the tension relieving device 92, including a third accumulator 92a, a fourth tension pickup 92b, and a fourth dancer roll 92c, which is provided between the third processing device 130 (the processing rollers 80 and 81) and the take-up roller 88.

In the embodiment of the present invention, any material which is conventionally used for fuel cells can be used as the electrode membrane 10. For example, Nafion (Registered Mark) 112 and 115 (DuPont), which is a perfluoro sulfuric acid electrolyte membrane, is preferable, but the present invention is not limited to this example. Further, the thickness of the electrolyte membrane 10 is not specifically limited as long as the membrane allows rapid movement of hydrogen ions and also the membrane has a strength with which the membrane is not damaged by a series of transportation and bonding processing, and is preferably about 10 to 100 μm, for example.

In the electrode material assembly manufacturing apparatus illustrated in FIG. 6, the electrolyte membrane 10 is transported by a plurality of drive rollers (the supply roller 84, the transportation rollers 86a and 86b, the processing rollers 60, 61, 70, 71, 80 and 81, and the take-up roller 88). Accordingly, even when any deficiency occurs in the electrolyte membrane 10 being transported for some reason, preferable manufacturing can be continued until the final product at the processing locations where excellent items are formed, which are located downstream of the deficient location, which advantageously contributes to an increase in yield of the assembly materials, especially the electrolyte membrane 10.

On the other hand, among the tension relieving devices preferably used in the electrode material assembly manufacturing apparatus illustrated in FIG. 6, the transportation buffering device such as the accumulator is especially preferably used when a change in the transportation speed of the electrolyte membrane 10 is significant and the electrolyte membrane 10 is likely to receive relatively large tension, such as immediately after the start of the electrode material assembly manufacturing apparatus (immediately after the start of transportation of the electrolyte membrane 10) or when tension relieving is continuously performed for a relatively long period such as several tens of seconds or several minutes, in some cases, for example. In other words, while such a device is not suitable for subtle tension relieving, such a device is particularly advantageous when it is necessary to relieve the tension to a relatively large degree. For this reason, such a device is preferably used on the downstream side of the supply roller 84 as with the accumulator 62a or on the upstream side of the take-up roller 88 as with the accumulator 92a. Further, the use of the accumulator as a tension relieving device can eliminate the need for stopping the apparatus at the time of replacement of the roll or allows continuous processing to a certain degree even during the replacement of the rolls, thereby contributing to increase in the production efficiency and yield.

As described above, according to the embodiments and modification examples, it is possible to efficiently manufacture a fuel cell electrode material assembly with high assembling accuracy.

### INDUSTRIAL APPLICABILITY

The present invention can be preferably used for manufacturing of a fuel cell electrode assembly, and a fuel cell which uses the same.

1. A manufacturing apparatus for an electrode material assembly for a fuel cell, for bonding an electrode material to each of two surfaces of an electrolyte membrane being continuously transported,
the manufacturing apparatus comprising:
a drive mechanism which transports the electrolyte membrane in a predetermined direction; and
a tension relieving mechanism which relieves tension of the electrolyte membrane with respect to a transportation direction.

2. The manufacturing apparatus according to claim 1, wherein
the drive mechanism is composed of a plurality of drive units, and
the tension relieving mechanism includes tension relieving units each provided between each pair of the drive units.

3. The manufacturing apparatus according to claim 1, wherein
a plurality of processing locations for applying different types of processing to the electrolyte membrane being transported are provided, and
the tension relieving mechanism includes tension relieving units independently provided at the processing locations, respectively.

4. The manufacturing apparatus according to claim 3, wherein
each of the plurality of processing locations includes processing rollers through which the electrolyte membrane passes, and
a circumference of each processing roller is set based on a difference in processing time among the processing locations.

5. The manufacturing apparatus according to claim 3, wherein
each of the plurality of processing locations includes a plurality of processing rollers through which the electrolyte membrane passes, and
the number of the processing rollers at each processing location is set based on a difference in processing time among the processing locations.

6. The manufacturing apparatus according to claim 1, wherein
the tension relieving mechanism includes a plurality of tension relieving devices.

7. A manufacturing apparatus for an electrode material assembly for a fuel cell,
the manufacturing apparatus comprising:
a supply unit which supplies an electrode material on a surface of an electrolyte membrane being continuously transported;
an information acquiring unit which acquires movement information of the electrolyte membrane; and
a supply control unit which controls supply of the electrode material by the supply unit based on the movement information which is acquired,
wherein
the movement information is information concerning a position or a speed of the electrolyte membrane.

8. The manufacturing apparatus according to claim 7, wherein
the movement information is information concerning a position or a speed of a specific portion of the electrolyte membrane.

9. The manufacturing apparatus according to claim 7, wherein
the information acquiring unit identifies an identifier provided in a specific portion of the electrolyte membrane to acquire the movement information of the electrolyte membrane.

10. The manufacturing apparatus according to claim 7, further comprising:
a bonding unit which bonds the electrode material onto a surface of the electrolyte membrane,
wherein
bonding conditions of the electrode material are controlled in accordance with a change in a transportation speed of the electrolyte membrane.

11. The manufacturing apparatus according to claim 1, wherein
the electrode material includes an electrode catalyst layer material which is previously formed on a surface of a sheet-like base material and which is to be supplied to a predetermined position of a surface of the electrolyte membrane and bonded thereto.

12. The manufacturing apparatus according to claim 7, wherein
the electrode material includes an electrode catalyst layer material which is previously formed on a surface of a sheet-like base material and which is to be supplied to a predetermined position of a surface of the electrolyte membrane and bonded thereto.

13. The manufacturing apparatus according to claim 12, wherein
the electrode material further includes an electrode diffusion layer material which is previously formed in a sheet-like form and which is to be supplied to a surface of the electrode catalyst layer material bonded to the surface of the electrolyte membrane, and bonded thereto.

14. An electrode material assembly for a fuel cell which is manufactured by the manufacturing apparatus according to claim 1.

15. A fuel cell including the electrode material assembly for a fuel cell according to claim 14.

16. A fuel cell including the electrode material assembly for a fuel cell manufactured by the manufacturing apparatus according to claim 7.

17. A manufacturing method for an electrode material assembly for a fuel cell, which is formed of an electrode material bonded on each of two surfaces of an electrolyte membrane,
the manufacturing method comprising:
a step of continuously transporting the electrolyte membrane;
a plurality of processing steps of applying different types of processing to the electrode membrane being transported; and
a tension relieving step of relieving tension of the electrolyte membrane with respect to a transportation direction,
wherein
the tension relieving step is performed at least corresponding to each of the processing steps.

18. A manufacturing method for an electrode material assembly for a fuel cell,
the manufacturing method comprising:
a step of acquiring movement information of an electrolyte membrane being continuously transported; and
a step of controlling supply of the electrode material based on the movement information which is acquired,
wherein
the movement information includes information concerning a position or a speed of a specific portion of the electrolyte membrane.

19. A fuel cell including the electrode material assembly for a fuel cell which is manufactured by the manufacturing method according to claim 16.

20. A fuel cell including the electrode material assembly for a fuel cell which is manufactured by the manufacturing method according to claim 17.
